(19) United States
(12) Patent Application Publication
(10) Pub. No.: US 2004/0212908 A1
(43) Pub. Date: Oct. 28, 2004

(54) Frame structure to support a mirror inside a vehicle

(76) Inventor: Mario Campion, Varennes (CA)

Correspondence Address: INVENTARIUM, SUITE 1607, 4050, ROSEMONT BLVD, MONTREAL, QC, H1X1M4, CA

(21) Appl. No.: 10/829,082

(22) Filed: Apr. 22, 2004

Related U.S. Application Data
(60) Provisional application No. 60/465,516, filed on Apr. 28, 2003.

(51) Int. Cl. G02B 5/08

(52) U.S. Cl. 359/879; 359/871

(57) ABSTRACT

A frame structure to support a mirror inside a vehicle consists of a flexible, pliable yet rigid frame structure having two opposite ends, one end having an adhesive band to adhere to an interior surface of a vehicle and a second end onto which is fixedly attached a mirror.

This application claims priority based on provisional application 60/465,516 filed Apr. 28, 2003 for claims 1-5.

### BACKGROUND OF THE INVENTION

1. Field of the Invention

This invention relates generally to mirrors but more particularly to a frame structure that supports a mirror which increases safety for drivers.

2. Background

The prior art reveals several different types of mirrors created to eliminate blind spots. Indeed, a conventional rearview mirror can only reflect a percentage of what is behind a car and side mirrors also have limited angles of view. It is possible, by carefully adjusting the left and right side mirrors as well as the rearview mirror to view virtually everything through mirrors until peripheral vision or a slight turning of one's head can catch whatever needs to be viewed but this involves three well adjusted mirrors. That is why convex mirrors have been developed. The problem with implementing convex mirrors in passenger cars in particular is that they can be viewed as cumbersome or difficult to install or both.

There is therefore a need for a small easy to install mirrors.

### SUMMARY OF THE INVENTION

It is therefore a first object of this invention to provide for a mirror support structure that is compact and easy to install.

It is a second object of this invention to provide for a mirror which is orientable so as to adjust to various drivers simply by rearranging the frame structure's bends and/or by reorienting the mirror.

In order to do so, the present invention consists of a flexible, pliable yet rigid frame structure having two opposite ends, one end having an adhesive band to adhere to an interior surface of a vehicle and a second end onto which is fixedly attached a mirror or, alternatively an orientable mirror is rotationally attached by way of a combination ball joint/ball joint receptacle extending from the frame's second end. Ideally, the frame structure are to be installed on a vehicle's door and on the side that is in the interior of the vehicle, but other locations are suitable as long as they allow for a mirror to provide useful viewing.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

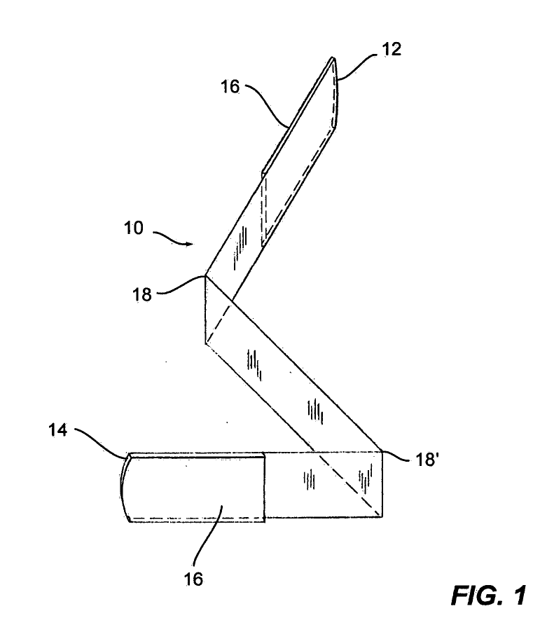

FIG. 1 Perspective view of a first embodiment of the mirror and its frame structure.

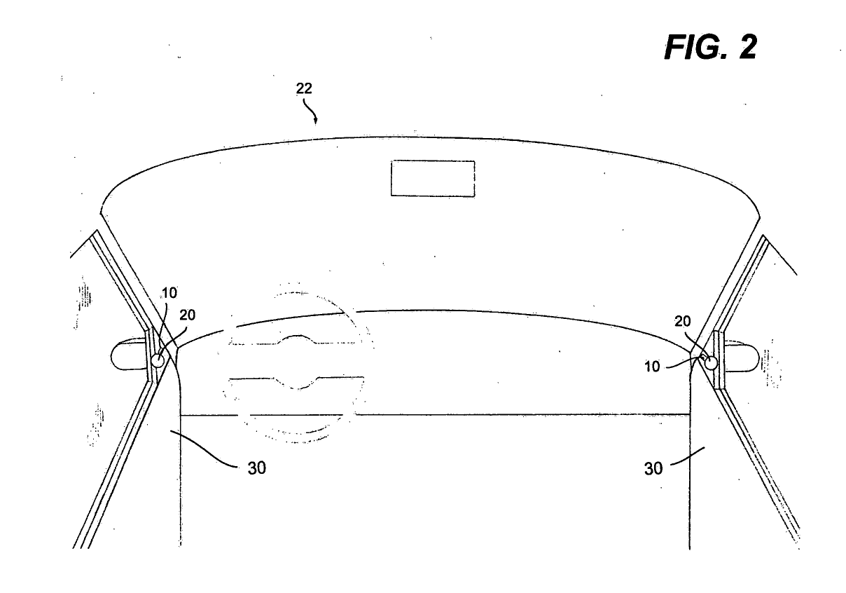

FIG. 2 Perspective view of two possible location for the mirror inside a vehicle.

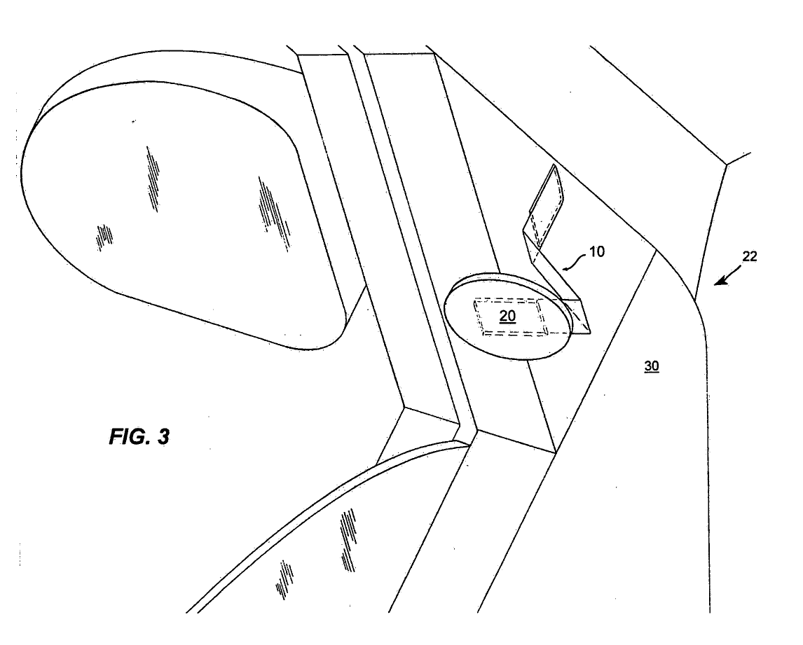

FIG. 3 Close up perspective view of the mirror.

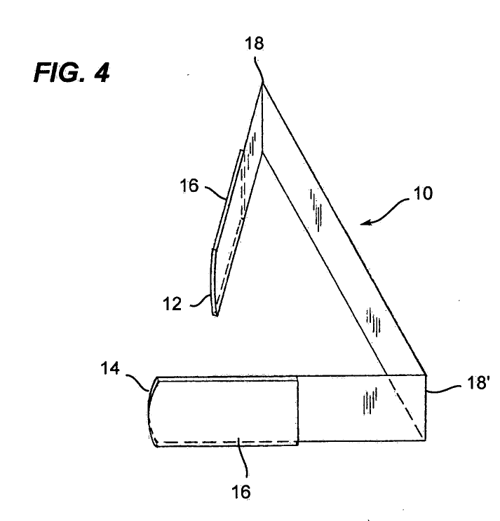

FIG. 4 Perspective view of a second embodiment of the mirror and its frame structure.

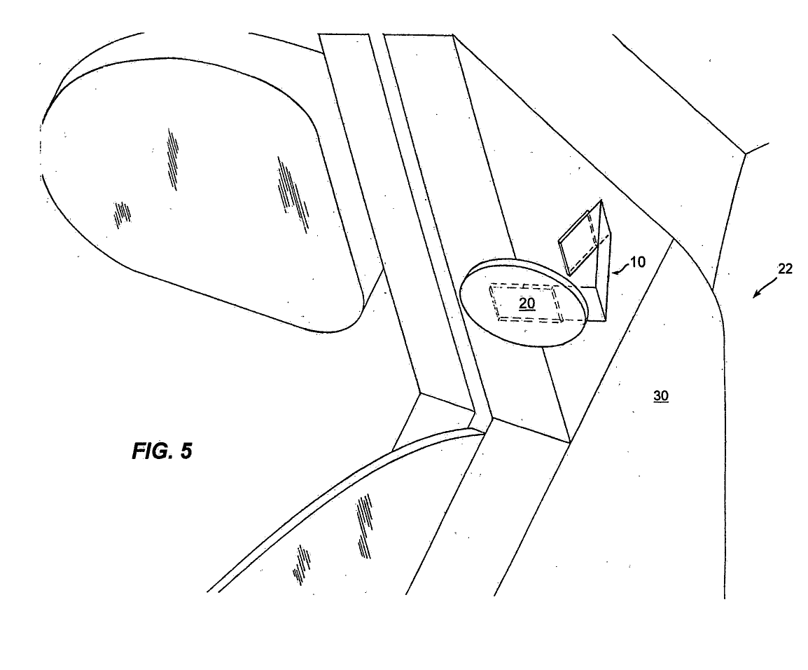

FIG. 5 Close up perspective view of the second embodiment mirror.

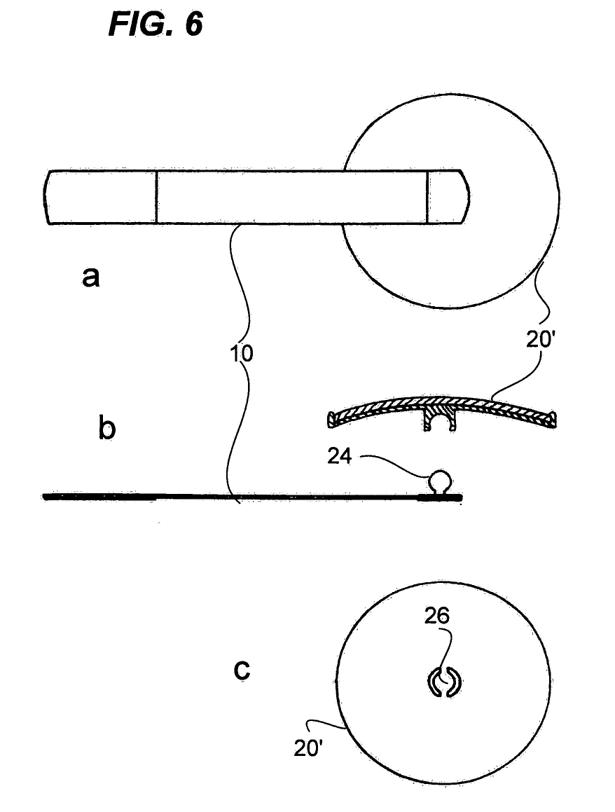

FIG. 6a Rear plan view of a third embodiment mirror.

FIG. 6b Side view, exploded, of the third embodiment orientable mirror.

FIG. 6c Rear view of the third embodiment orientable mirror.

### DETAILED DESCRIPTION OF THE PREFERRED EMBODIMENTS

Referring more particularly to FIGS. 1, 2 and 3 a flexible, pliable yet rigid frame structure (10) has two opposite ends with a first end (12) having an adhesive substance (16) that adheres to a part of a vehicle (22) and a second end (14) also having an adhesive substance (16) onto which a mirror (20) can be adhered to. The exact location of the frame structure (10) is adhered to depends on the interior design of the vehicle and a user's own preference. The frame structure (10) is pliable along two bends (18, 18′) which gives the frame a given configuration such as an inverted “Z” like configuration as per FIG. 1. The frame structure (10) has been previously kinked during the manufacturing process in order to present actual bending points at the two bends (18, 18′) but for shipping, it is preferable that the frame structure (10) be as flat as possible to lower shipping costs.

The frame structure (10) can be positioned either to the left or the right inside a vehicle (22) or both, preferably at a location proximal a vehicle's door or directly on the door (30).

Referring to FIGS. 4, 5, an alternate bend of the frame structure (10) which gives the frame a triangular configuration which also produces a silmilar result, but with the difference that the adhesive substances (16) are on the same side of the frame structure (10) in this embodiment, as opposed to being on alternate sides of the frame structure as per the embodiment of FIG. 1. The variation in the way the bends are made is sufficiently minimal to fall within the scope of a single invention. The adhesive substances are covered with a peel and stick film (not shown) as is well known in the art.

FIG. 6 In this variation which can be applied to both types of bends (as per FIG. 1 and FIG. 4) a mirror (20′) is orientable by way of a ball joint (24) extending from the frame structure (10) and which cooperates with a ball joint receptacle (26) situated at the back of the mirror (20′). In this embodiment, the ball joint (24) replaces the adhesive substance (16), although the ball joint could be adhered to the adhesive substance (16). In the case of a ball joint (24) being adhered to the frame structure (10), any of the two previously described embodiments could be used with the alternate mirror (20′) having the ball joint receptacle (26) at its back. It should be obvious, however, that the ball joint receptacle (26) could alternatively be on the frame structure (10), either extending therefrom or adhesively attached onto with the ball joint (24) at the back of the mirror (20′).

In order to make the mirror (20, 20′) more efficient, it is preferable to use a convex mirror which shows a larger field of view.

In order to install the frame structure (10), a user peels off a peel and stick film from an adhesive substance (16) situated on a first end (12), applies said adhesive substance (16) proximal a door (30) inside a vehicle (22), installs a mirror (20, 20′) on a second end (14)—unless of course a mirror is already factory installed—after having removed that second end's (20) peel and stick film, and Induces the proper bends into the bends (18, 18′) of said frame structure (10) so as to provide adequate placement of the mirror (20, 20′).

1. A frame structure to support a mirror inside a vehicle comprising:
a flexible, pliable frame structure having two opposite ends;
a first end having an adhesive substance to adhere to a part of a vehicle;
a second end onto which an attachment means attaches said mirror;
said frame structure being pliable along two bends to obtain a given configuration.

2. A frame structure to support a mirror inside a vehicle as in claim 1 wherein:
said frame structure bends along a <<Z>> like configuration.

3. A frame structure to support a mirror inside a vehicle as in claim 1 wherein:
said frame structure bends along a triangular configuration.

4. A frame structure to support a mirror inside a vehicle as in claim 1 wherein:
said mirror is adhesively attached to said second end.

5. A frame structure to support a mirror inside a vehicle as in claim 1 wherein:
said frame structure being adhered on a vehicle's door and on the side that is in the interior of said vehicle.

6. A frame structure to support a mirror inside a vehicle having the following method of installation: a user peels off a peel and stick film from an adhesive substance situated on a first end, applies said adhesive substance proximal a door inside a vehicle; installs a mirror on a second end unless said mirror is factory installed; and induces the proper bends into bends on said frame structure so as to provide adequate placement of said mirror.

7. A frame structure to support a mirror inside a vehicle as in claim 1 wherein: said mirror is attached to said second end by way of a ball joint extending from the frame structure's second end and which cooperates with a ball joint receptacle situated at the back of said mirror.

8. A frame structure to support a mirror inside a vehicle as in claim 1 wherein:
said mirror is attached to said second end by way of a ball joint receptacle extending from the frame structure's second end and which cooperates with a ball joint situated at the back of said mirror.

9. A frame structure to support a mirror inside a vehicle as in claim 6 wherein:
said ball joint being adhesively attached to said frame structure.

10. A frame structure to support a mirror inside a vehicle as in claim 7 wherein:
said ball joint receptacle being adhesively attached to said frame structure.
